(19) United States
(12) Patent Application Publication
(10) Pub. No.: US 2020/0331677 A1
(43) Pub. Date: Oct. 22, 2020

(54) Container Strap System

(71) Applicants: Kieran Connor Drexler, Martinsville, IN (US); Garrett Christopher Lloyd, Indianapolis, IN (US); Garrett Antone Nogoda, Indianapolis, IN (US); Wyatt Lee Scott, Mooresville, IN (US); Matthew Adrian McDonald, Pittsboro, IN (US); Payton Leslie Pierce, Noblesville, IN (US)

(72) Inventors: Kieran Connor Drexler, Martinsville, IN (US); Garrett Christopher Lloyd, Indianapolis, IN (US); Garrett Antone Nogoda, Indianapolis, IN (US); Wyatt Lee Scott, Mooresville, IN (US); Matthew Adrian McDonald, Pittsboro, IN (US); Payton Leslie Pierce, Noblesville, IN (US)

(21) Appl. No.: 16/386,598

(22) Filed: Apr. 17, 2019

(51) Int. Cl. B65D 63/14; E05B 67/00

(52) U.S. Cl. CPC B65D 63/14; B65D 2563/107; E05B 67/003

(57) ABSTRACT

A container securing system of straps and containers. The containers are configured with a plurality of pass-through loops on side zones. The guide loops receive a strap that secures the containers together and secures them in the closed position. The securing strap is secured to the container through a locking lock positioned below the guide loop.

### TECHNICAL FIELD

The present disclosure generally relates to the system for the securing of a variety of storage containers and in particular, to a method of allowing similar or different containers outfitted with a strap lock to be securely coupled in multiple configurations with the use of an accompanying strap.

### BACKGROUND

This section introduces aspects that may help facilitate a better understanding of the disclosure. Accordingly, these statements are to be read in this light and are not to be understood as admissions about what is or is not prior art.

Previous methods of storage can be single containers that are unconnected and unfixed. For example, a container used for food storage may have a handle and is a single-use container that is not connected to any other containers. In order to carry multiple containers, a possible previous solution would have been a plastic bag to secure the containers together for easier transportation. However, a bag is not an efficient and effective means of securing storage containers together and in a closed position.

Therefore, there is an unmet need for a novel approach to aid in the efficient and effective securing of a variety of storage containers.

### SUMMARY

The intent of this invention is to provide a way of connecting multiple containers using an adjustable strap for convenience. According to the present invention, there is provided a strap with perforated increments which connects to multiple containers of various size and shape using a strap guide and a strap lock. These and other objects and features of the present invention will become more apparent from the following detailed description with reference to the accompanying drawings.

### BRIEF DESCRIPTION OF DRAWINGS

FIG. 1 is a perspective view of an embodiment of the container strap system showing two containers in different embodiments, according to the present disclosure.

FIG. 2 is a side view of an embodiment of a container with an attached strap showing the attachment of the strap, according to the present disclosure.

FIG. 3 is a perspective view of an embodiment of the strap guide and strap lock, according to the present disclosure.

FIG. 4 is a perspective view of an embodiment a container with an attached strap showing the attachment of the strap, according to the present disclosure.

FIG. 5 is a side view of an embodiment of a container, according to the present disclosure.

FIG. 6 is a perspective view of an embodiment of a sub-system of a strap, strap guide, and strap lock, according to the present disclosure.

FIG. 7 is a flow chart of the method according to the present disclosure, that is spanned over 12 pages.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

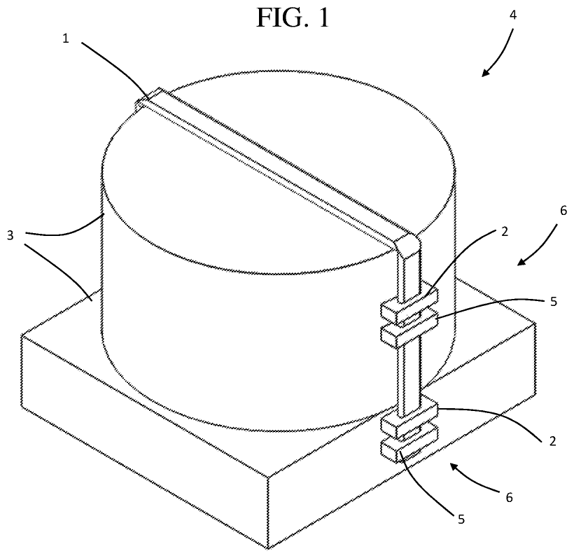

FIG. 1 is a perspective view of an embodiment of the container strap system 4 showing two containers 3 in different embodiments, according to the present disclosure. The system is comprised of two embodiments of containers 3, strap 1, strap guides 2, and strap locks 5. The strap 1 is configured to slide through the strap guide 2 and strap lock 5 of each embodiment of container 3 to secure the container 3 in place relative to the adjacent container embodiment. The strap guide 2 is positioned to be located above the strap lock 5 when the embodiment of the container 3 is oriented so that the top is facing in the upward direction. The strap lock 5 is positioned below the strap guide 2 to secure the strap 1 in a stationary position determined by the user, not allowing the strap 1 to pass back through strap lock 5 in the opposite direction.

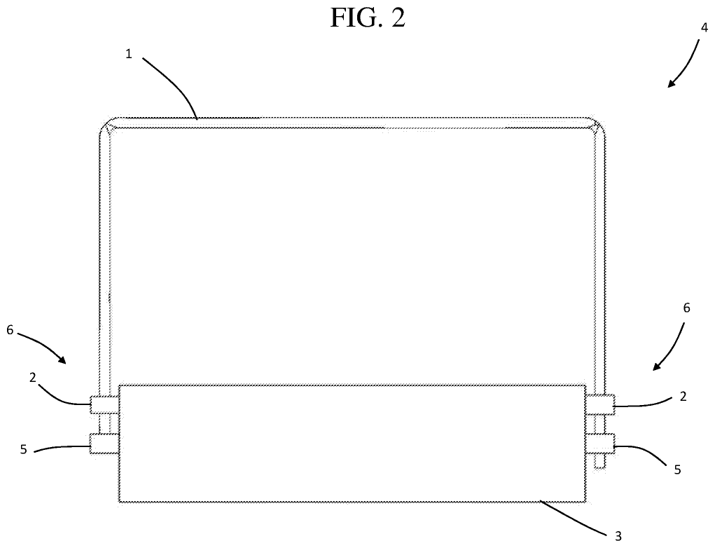

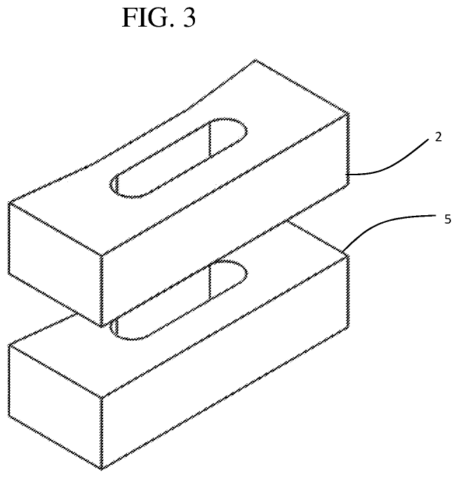

FIG. 2 is a side view of an embodiment of a container 3 with attached strap 1 showing the attachment of the strap, according to the present disclosure. The embodiment of the container 3 is comprised of a sub-system 6, comprised of both a guide 2 and strap lock 5 for securing a strap 1, through said strap guide 2 and strap lock 5, at a varying length. This side view also shows the positioning of having the strap lock 5 below the guide 2 on opposing sides of the embodiment of a container 3.

FIG. 3 is a perspective view of an embodiment of the strap guide and strap lock, according to the present disclosure. The embodiment of the strap guide 2 will be located in a central location on one of the side zones of the embodiment of the containers 3. The location of the strap guide 2 will be such that it is located directly above the strap lock 5 to allow the strap 1 to pass through the strap guide 2 and the strap lock easily without deformation or bending. The strap guide 2 will restrict the strap's movement in all directions with the exception of the vertical movement for the strap to slide through the strap guide 1 and through the strap lock 5. The purpose of the strap guide is to allow for proper interaction between the strap lock 5 and the strap 1. There should be a sufficient vertical spacing between the strap guide 2 and the strap lock 5 to allow for a hand cutting tool, such as a container cutting tool or scissors to be able to sever the strap 1 if necessary. The “sufficient spacing” shall be between 5 millimeters and 500 millimeters, depending on the size limitations of the multiple embodiments of the container 3.

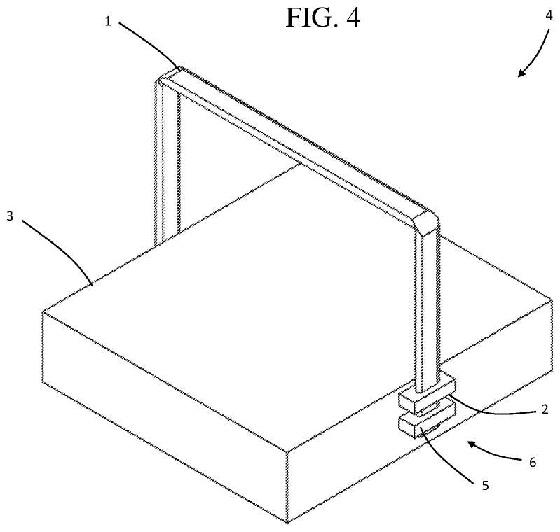

FIG. 4 is a perspective view of an embodiment of a container 3 with attached strap 1 showing the attachment of the strap, according to the present disclosure. The embodiment of the container 3 is comprised of a sub-system 6, comprised of both a strap guide 2 and strap lock 5 for securing a strap 1, through said strap guide 2 and strap lock 5, at a varying length. This perspective view also shows the positioning of having the strap lock 5 below the strap guide 2 on opposing sides of the embodiment of a container 3. The strap 1 starts at one strap lock 5 and travels through a strap guide 2 over the total desired containers to another separate strap guide 2 to connect with a strap lock 5 to secure the system.

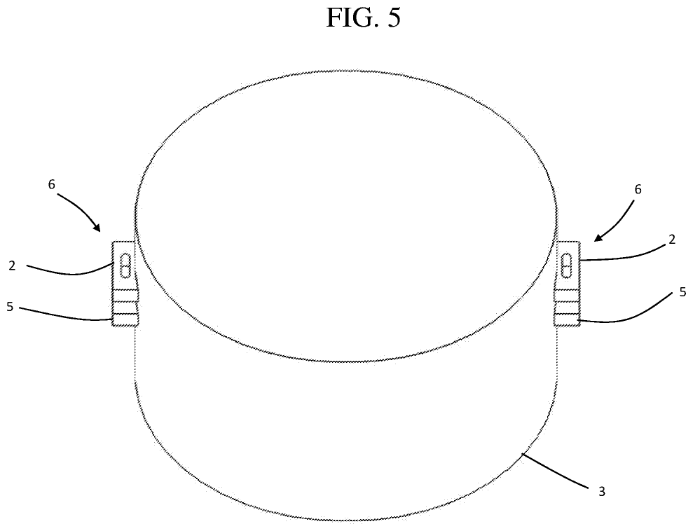

FIG. 5 depicts a side view of an embodiment of a container 3, according to the present disclosure. The embodiment of the container 3 is comprised of a sub-system 6, comprised of both a strap guide 2 and strap lock 5 for securing a strap, through said strap guide 2 and strap lock 5, at a varying length. This side view also shows a general positioning of having the strap lock 5 below the guide 2 on opposing sides of the embodiment of a container 3.

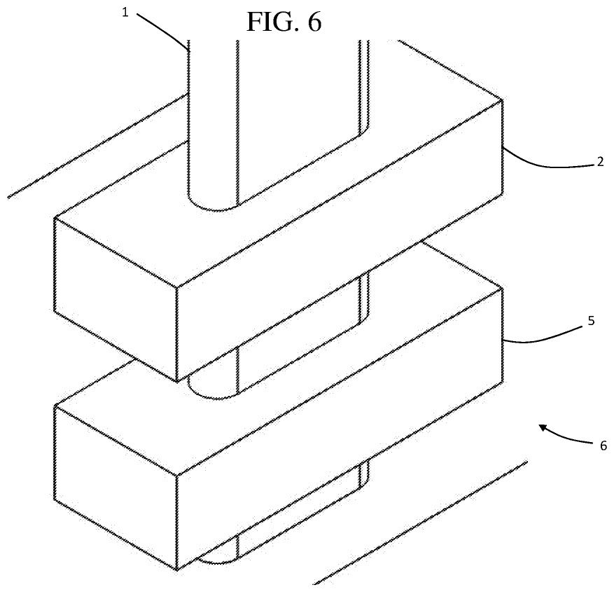

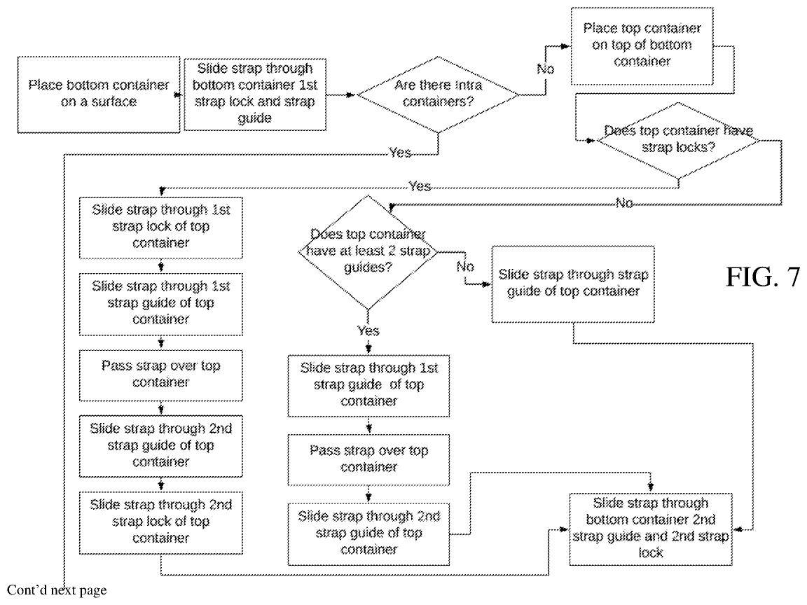

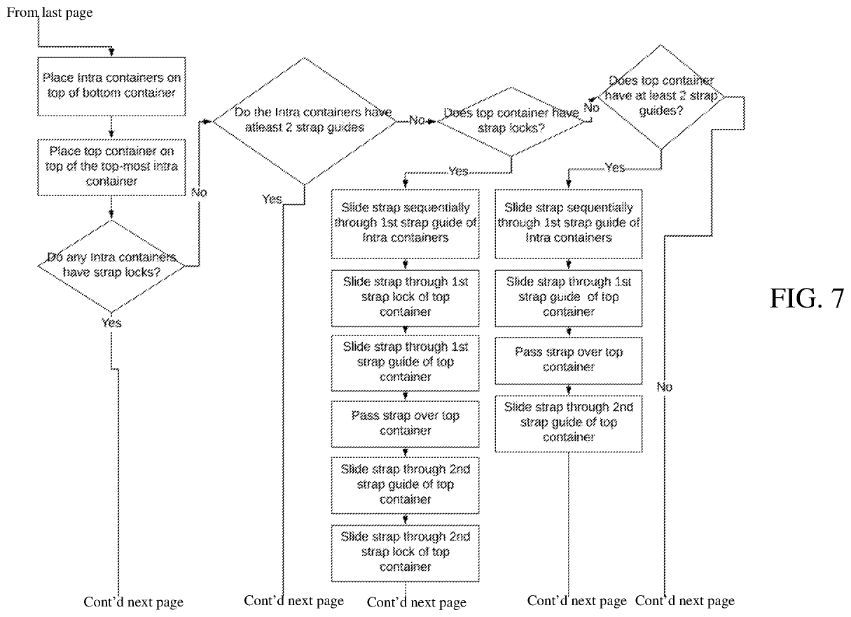

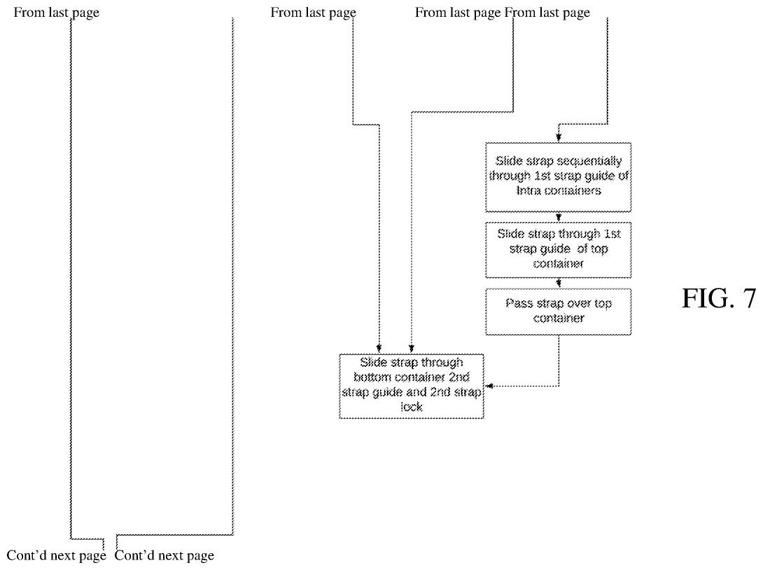

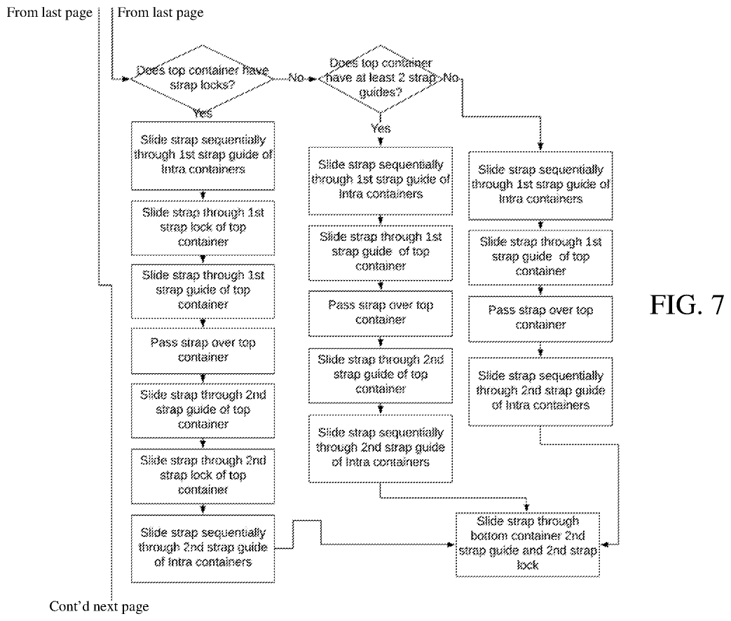

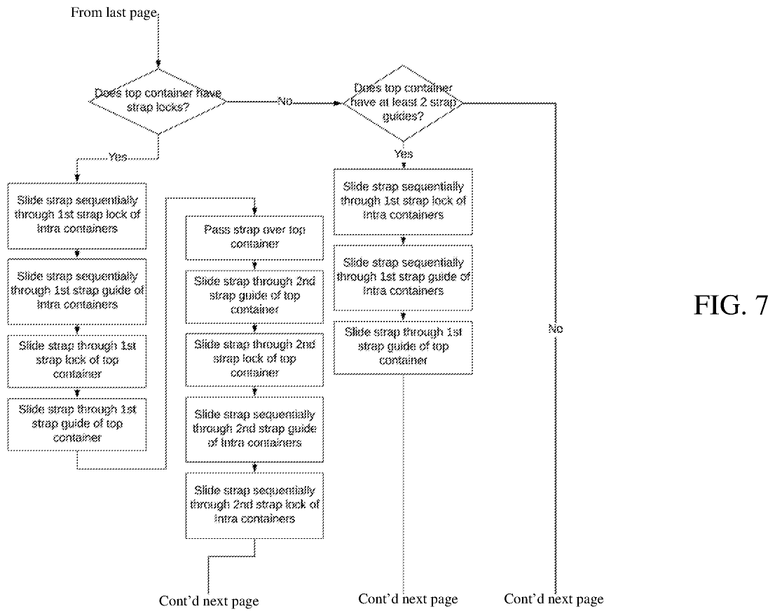

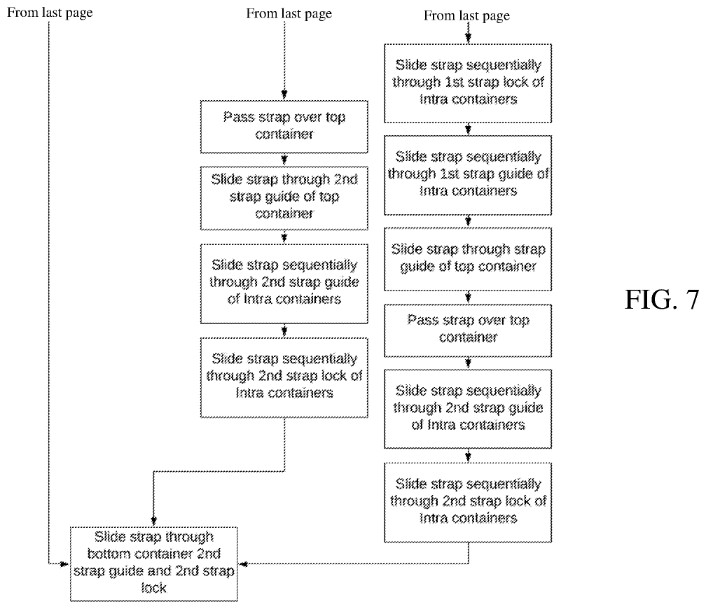

FIG. 6 depicts an embodiment of a strap and locking subsystem 6. The system is composed of the strap 1, strap guide 2, and the strap lock 5 according to the present disclosure. Both the strap guide 2 and the strap lock 5 are coupled to the embodiment of the container 3. The strap guide 2 is positioned to be located above the strap lock 5 when the embodiment of the container 3 is oriented so that the top is facing in the upward direction. The strap 1 will be passed through the strap guide 2 prior to being passed through the strap lock 5. The strap guide 2 will act as a supportive brace to ensure proper interaction between the strap 1 and the strap lock 5. The strap 1 will continue to pass through the strap lock 5 the two will interact in a way as to not allow the strap 1 pass back through the strap lock 5 in the opposite direction of which it came, thus directionally locking the strap 1 at a level determined by the user. The strap 1 embodied so that when interacting with the strap lock 5 is adjustable so that the strap 1 is secured at predetermined intervals. This operation of the strap guide and strap lock subsystem 6 allows the container strap system 4 to behave as an adjustable system capable of securing a wide variety of container 3 embodiments.

Those having ordinary skill in the art will recognize that numerous modifications can be made to the specific implementations described above. The implementations should not be limited to the particular limitations described. Other implementations may be possible.

### REFERENCE NUMERAL LIST

| | |
|---|---|
| Strap | 1 |
| Strap guide | 2 |
| Container | 3 |
| Container strap system | 4 |
| strap lock | 5 |
| Strap, guide and lock sub-system | 6 |

1. A system for securing at least two containers, comprising;
a bottom container and a top container;
a strap;
at least one strap guide disposed on a side of the top container; and
at least one pair of strap locks, one on each opposing sides of the bottom container;
wherein the strap is latched in the at least one pair of strap locks and guided through at least one strap guide to thereby secure positions of the top and bottom containers with respect to one another.

2. The system for securing at least two containers of claim 1, further comprising:
at least two strap guides, one on each opposing sides of the top container.

3. The system for securing at least two containers of claim 2, further comprising:
at least one intra container disposed between the top container and the bottom container, the at least one intra container having at least one strap guide disposed on a side of the at the at least one intra container, wherein the strap is guided through the at least one strap guide of the at least one intra container to thereby secure positions of the top and bottom containers and the intra container with respect to one another.

4. The system for securing at least two containers of claim 3, further comprising:
at least two strap guides, one on each opposing sides of the at least one intra container.

5. The system for securing at least two containers of claim 4, further comprising at least one pair of strap locks, one on each opposing sides of the at least one intra container;
wherein the strap is latched in the at least one pair of strap locks and guided through at least one strap guide of the top container to thereby secure positions of the top, bottom and intra containers with respect to one another.

6. The system for securing at least two containers of claim 5, further comprising at least one pair of strap locks, one on each opposing sides of the top container;
wherein the strap is latched in the at least one pair of strap locks and guided through at least one strap guide of the top container; wherein the length of the strap passing over the top container, between the at least one pair of strap locks of the top container, will provide enough distance between the top container and the strap to allow a hand to grasp the strap providing a sufficient handle to lift the system for securing at least two containers

7. The system for securing at least two containers of claim 1, further comprising the strap which will comprise perforations along the cross-section at least along a first portion to allow the strap to be severed from itself.

8. A method of using a system for securing at least two containers, comprising;
placing a bottom container on a surface;
placing at least a top container having at least one strap guide, directly on top of the bottom container;
sliding the strap through the bottom container first strap lock and first strap guide;
passing the strap through the top container strap guide;
passing over the top of the top container; and
sliding the strap through the second strap guide and strap lock of the bottom container.

9. The method of claim 9, further comprising;
sliding the strap through the bottom container first strap lock and first strap guide;
passing the strap through a first strap guide of the at least two strap guides of the top container; and
passing over the top of the top container and passing through the second strap guide of the at least two strap guides of the top container and finally sliding the strap through the second strap guide and strap lock of the bottom container.

11. The method of claim 8, further comprising:
sliding the strap through the bottom container first strap lock and first strap guide;
passing the strap through a first strap guide and strap lock of the at least two strap guides and strap locks of the top container, and passing over the top of the top container; and
passing through the second strap guide and strap lock of the at least two strap guides and strap locks of the top container and finally sliding the strap through the second strap guide and strap lock of the bottom container.

12. The method of claim 8, further comprising;
placing the bottom container on a surface;
placing at least one intra container on top of the bottom container; and
placing the top container comprising at least one strap guide, directly on top of the topmost intra container.

13. The method of claim 12, further comprising;
sliding the strap through the bottom container first strap lock and first strap guide;
passing the strap through the at least one strap guide of the at least one intra container;
passing the strap through the at least one strap guide of the top container; and
passing over the top of the top container and finally sliding the strap through the second strap guide and strap lock of the bottom container.

14. The method of claim 12, further comprising;
sliding the strap through the bottom container first strap lock and first strap guide;
passing through the at least one strap guide of the at least one intra container;
passing the strap through a first strap guide of the at least two strap guides of the top container; and
passing over the top of the top container and passing through the second strap guide of the at least two strap guides of the top container and finally sliding the strap through the second strap guide and strap lock of the bottom container.
